(19) United States
(12) Patent Application Publication
(10) Pub. No.: US 2014/0222460 A1
(43) Pub. Date: Aug. 7, 2014

(54) ADAPTIVE HEALTHCARE SYSTEM

(71) Applicant: HEALTHSENSE, INC., Mendota Heights, MN (US)

(72) Inventors: Brian J. Bischoff, Red Wing, MN (US); Dean S. Anderson, Cologne, MN (US); Julie A. Bischoff, Red Wing, MN (US)

(73) Assignee: HEALTHSENSE, INC., Mendota Heights, MN (US)

(21) Appl. No.: 13/758,628

(22) Filed: Feb. 4, 2013

(51) Int. Cl. G06F 19/00; G06Q 50/22

(52) U.S. Cl. CPC G06F 19/322; G06Q 50/22
USPC 705/3

(57) ABSTRACT

The present disclosure includes method and devices to implement an adaptive healthcare system. A number of embodiments include creating a healthcare file for each of a number of persons, wherein each of the healthcare files includes outcomes associated with changes in a lifestyle and/or medical condition of the number of persons, adjustments to the lifestyle and/or treatment of the number persons, and observations of the number of persons in an environment; and adapting healthcare of the number of persons using decision support based on the healthcare files.

### BACKGROUND OF THE DISCLOSURE

Methods, devices, and systems have been developed in various fields of technology for monitoring the healthcare of an individual. With respect to the monitoring of the healthcare of an individual, some methods, devices, and systems have been developed to aid in the diagnosis and treatment of individuals.

In the field of healthcare monitoring, for instance, systems have been developed to enable an individual to contact medical professionals from their dwelling regarding a medical emergency. For example, in various systems, a system is equipped with an emergency call button on a base station that initiates a call or signal to an emergency call center from a user's home telephone. The concept of such a system is that if an individual has a health related problem, they can press the emergency call button and emergency medical providers will respond to assist them.

Systems have also been developed that use sensors within the home to monitor an individual within a dwelling and/or to aid in the diagnosis of medical conditions of an individual. These systems can include motion sensors, for example, that are connected to a base control system that monitors areas within the dwelling for movement. In such systems, when a lack of movement is indicated, the system indicates the lack of movement to a remote assistance center that can contact a party to aid the individual.

With respect to diagnosis and treatment, some systems can be used to aid in the diagnosis medical conditions. For example, in one system, the daily routine of the individual that is monitored using sensors can be used by healthcare professionals to indicate symptoms of a medical condition. Such systems have been developed to automate the collection and analysis of the data from the sensors regarding an individual daily routine.

Furthermore, the means now exist to suggest actions in response to observations from these sensing systems and subsequently record the outcomes from these actions. The outcomes may be self-reported, measured by the sensor system or taken from utilization of health care services recorded in an electronic medical record or medical claims database.

### BRIEF DESCRIPTION OF THE DRAWINGS

FIG. 1 illustrates an adaptive healthcare system in accordance with a number of embodiments of the present disclosure.

FIG. 2 illustrates a person in an environment of an adaptive healthcare system in accordance with a number of embodiments of the present disclosure.

FIG. 3 illustrates observations of an adaptive healthcare system in accordance with a number of embodiments of the present disclosure.

FIG. 4 illustrates actions of an adaptive healthcare system in accordance with a number of embodiments of the present disclosure.

FIG. 5 illustrates outcomes of an adaptive healthcare system in accordance with a number of embodiments of the present disclosure.

### DETAILED DESCRIPTION OF THE DISCLOSURE

The present disclosure includes method and devices to implement an adaptive healthcare system. A number of embodiments include creating a healthcare file for each of a number of persons, wherein each of the healthcare files includes outcomes associated with changes in a lifestyle and/or medical condition of the number of persons, adjustments to the lifestyle and/or treatment of the number persons, and observations of the number of persons in an environment; and adapting healthcare of the number of persons using decision support based on the healthcare files.

In a number of embodiments, an expert system can provide decision support for adapting the healthcare for a specific person. The expert system can be trained, e.g., self-learned, from information collected in a healthcare file for each of a number of persons to provide decision support for actions to adapt the healthcare provided to the number of persons. The healthcare files can include information about the person's medical history, the person's environment, observations of the person collected through a variety of means, actions in response to these observations and outcomes associated with these actions. The availability of means to observe and record changes in a person's activities and condition, to provide decision support for suggested actions in response to these observations and to subsequently record the outcomes of the suggested actions in nearly real-time presents an opportunity to build the healthcare files and train the expert system to provide decision support in near real-time regarding actions to adapt the healthcare provided to the number of persons. In previous methods, historical information gathered overtime and telehealth information gathered from a person's environment could each be used in isolation to make decisions regarding the health of the person and the healthcare that person should be receiving. In one or more embodiments of the present disclosure, the healthcare file that includes information regarding the environment of the person, observations of the person in the environment, actions of the person, and outcomes of the actions of the person can be used by an expert system to provide decision support for adapting the healthcare that is provided to the person.

In the following detailed description of the present disclosure, reference is made to the accompanying drawings that form a part hereof, and in which is shown by way of illustration how a number of embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure. As used herein, “a number of” something can refer to one or more of such things. For example, a number of persons can refer to one or more persons. As used herein, the designators, such as “N,” particularly with respect to reference numerals in the drawings, indicates that a number of the particular feature so designated can be included with a number of embodiments of the present disclosure.

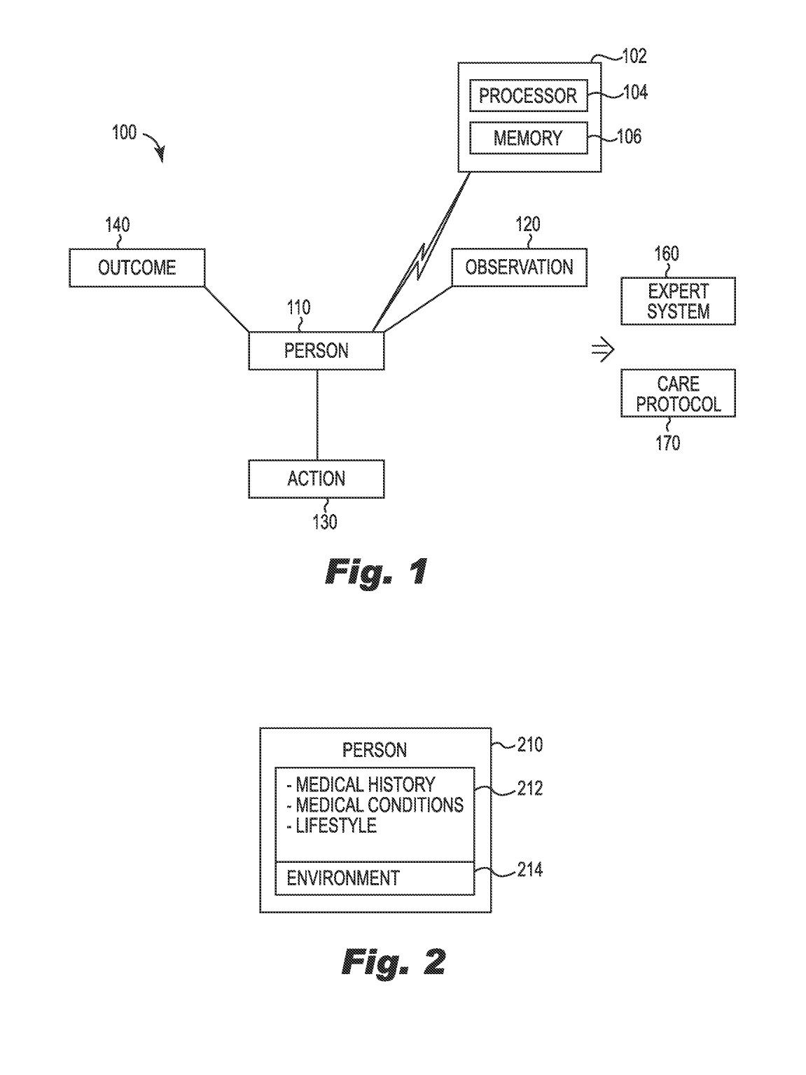

The figures herein follow a numbering convention in which the first digit or digits correspond to the drawing figure number and the remaining digits identify an element or component in the drawing. Similar elements or components between different figures may be identified by the use of similar digits. For example, 130 may reference element “30” in FIG. 1, and a similar element may be referenced as 430 in FIG. 4. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate the embodiments of the present invention, and should not be taken in a limiting sense.

FIG. 1 illustrates an adaptive healthcare system 100 in accordance with a number of embodiments of the present disclosure. The adaptive healthcare system 100 can include a person 110 in an environment, observations 120, actions 130, and outcomes 140. The person 110 in an environment, observations 120, actions 130, and outcomes 140 can be interconnected, wherein the information from the person 110 in an environment, observations 120, actions 130, and 130 outcomes can be shared amongst the person 110, observations 120, actions 130, and outcomes 140. The person 110 in the environment, observations 120, actions 130, and outcomes 140 can be used to determine how to adapt healthcare for a number of persons and/or to determine best healthcare protocols for a number of persons. For example, outcomes 140 including changes in lifestyle and/or medical condition of a person 110 can be based on observations 120 of actions 130, wherein the actions 130 adjust the lifestyle and treatment plan of the person 110. The actions 130 that adjust the lifestyle and treatment plan of the person can be based on observations 120 of the person 110. The information associated with the outcomes 140, actions 130, and observations 120 of a person 110 in an environment can be stored in healthcare files in a database and analyzed to determine how to adapt healthcare for the person, to determine best healthcare protocols for the person and/or similar persons, and/or provide decision support for providing healthcare for the person.

In a number of embodiments, observations 110 can include observations of a person that are determined by a sensor system, a healthcare provider, a medical device, and/or feedback from the person, among other forms of observations. The observations 110 can be used to record details about a person 110 in an environment, details of the person 110 performing actions 130, and details of outcomes 140 regarding the lifestyle and medical condition of the person 110. The observations 120 provide reporting functionality for the adaptive healthcare system 100.

The actions 130 can include adjustments to a person's lifestyle and/or treatment plan during implementation of healthcare. The actions 130 that include adjustments to a person's lifestyle and/or treatment plan can be based on observations 120 of the person 100 in an environment. Also, the person 110 in the environment can be observed while implementing actions 130 that include adjustments to the person's lifestyle and/or treatment plan.

The outcomes 140 can include changes to a person's lifestyle and/or medical conditions while providing healthcare to the person 110. The outcomes 140 that include changes to a person's lifestyle and/or medical conditions can be based on observations 120 of the person 110 in an environment. The person 110 in the environment can be observed while implementing actions 130 that include adjustments to the person's lifestyle and/or treatment plan to determine outcomes 140 include changes to a person's lifestyle and/or medical conditions.

In a number of embodiments, the adaptive healthcare system 100 can include expert system 160. Expert system 160 can analyze the observations 120, actions 130, and outcomes 140 of the person 100 in an environment in the adaptive healthcare system 100 to learn expected observations 120, actions 130, and outcomes 140 for the person 110. The expected observations 120, actions 130, and outcomes 140 for the person 110 learned during training of expert system 160 can be used to implement actions 130 that include changes to a person's lifestyle and/or medical conditions while providing healthcare to the person 110. The expert system 160 can be used by the adaptive healthcare system 100 to predict potential outcomes based on observations and in turn suggest and/or implement actions 130 that will lead to desired outcomes 140 and also to provide decision support for healthcare professionals when the healthcare professionals are providing health care to the person 110. Expert system 160 can use the information in a healthcare file to make an assessment of the person 110 and communicate the results of the assessment to healthcare professionals, the person 110, and/or the family of the person as decision support for the healthcare that is being provided to the person 110.

Expert system 160 can provide decision support by providing suggestions for healthcare actions that would benefit a person based on information in their healthcare file. Expert system 160 can also provide decision support by indicating what information would be helpful to make an assessment and how that information can be obtained. For example, expert system 160 can provide decision support by indicating that a person 110 should obtain a glucometer and use the glucometer to measure their blood sugar levels three times per day. The observations 120 and outcomes 140 from the adaptive healthcare system 100 can be used to provide decision support that makes suggestions regarding the methods of observation, the healthcare that is provided, and how the healthcare is provided. For example, the decision support of the expert system 160 can include suggestions regarding increasing or decreasing the number of blood sugar measurements, the diet of the person 100, and or medications of the person 100. The decision support provided by expert system 160 can provide recommendations for implementing interventions and/or implementing methods of observation. Expert system 160 can also provide decision support for the contents of a care plan and how to implement a care plan.

Expert system 160 can include using learned expected observations 120, actions 130, and outcomes 140 for a person in the environment 110 to perform an assessment of the person 110 in the environment. The expert system 160 can use the learned expected observations 120, actions 130, and outcomes 140 for a person in the environment 110 to provide decision support suggestions to a healthcare professional and/or actually implement actions 130 that include changes to a person's lifestyle and/or medical treatment plan. The expert system 160 can be self-learning, allowing the adaptive healthcare system 100 to supplement the diagnosis and/or treatment of person 110 that a healthcare professional is providing to person 110.

In a number of embodiments, the adaptive healthcare system 100 can include a care protocol 170. The care protocol 170 can include instructions on a treatment plan for a condition of a person 100. The care protocol 170 can use the observations 120, actions 130, and outcomes 140 of the person 100 in an environment to develop a care protocol for the person 110. The care protocol 170 can include implementation of actions 130 that include changes to a person's lifestyle and/or treatment while providing healthcare to the person 110. For example, care protocol 170 can include therapy and/or medical treatment recommendations to treat the conditions of person 110 that have been observed 120 by the healthcare system 100.

The care protocol 170 that is developed can be used as a best care protocol for people have similar observations, actions, and outcomes to the observations 120, actions 130, and outcomes 140 for the person 100 in an environment in the adaptive healthcare system 100. The outcomes 140 of the actions 130 implemented through training of the expert system 160 can be used to develop the care protocol 170. The care protocols 170 that are developed using the observations 120, actions 130, and outcomes 140 for the environment 110 and person can be used to establish standards throughout the medical field.

In a number of embodiments, the adaptive healthcare system 100 can be coupled to and implemented via a number of computing devices 102. The number of computing devices 102 can include a number of processors 104 and memory 106. The memory 106 can be a non-transitory computer readable medium. The processor 104 can execute commands stored in memory 106 to perform embodiments of the present disclosure. The memory 106 can be part of a database that stores healthcare files that include outcomes 140, actions 130, and observations 120 of a person in environment 110 and/or that stores assessment training 160 information and/or care protocol information 170.

FIG. 2 illustrates a person 210 in an environment 214 of an adaptive healthcare system in accordance with a number of embodiments of the present disclosure. The environment 214 of an adaptive healthcare system can include a number of persons 210 and a dwelling. The dwelling can include a single family home, an apartment, an assisted living facility, a nursing home, and/or a hospital, among other locations where persons reside. In one example, the environment 214 can include one person 210 living in a dwelling, such as a single family home. In another example, the environment 214 can include a number of persons 210 living in a dwelling, such as a nursing home.

The number of persons 210 can each have a medical history, medical conditions, medical care plan, and/or lifestyle information 212, among other information, stored in a healthcare file for each of the number of persons. The medical history information, medical conditions information, medical care plan information, and/or lifestyle information 212 of the number of persons 210 can be used by an adaptive healthcare system to adapt healthcare for the number of persons 210 and/or to determine best healthcare protocols for the number of persons 210.

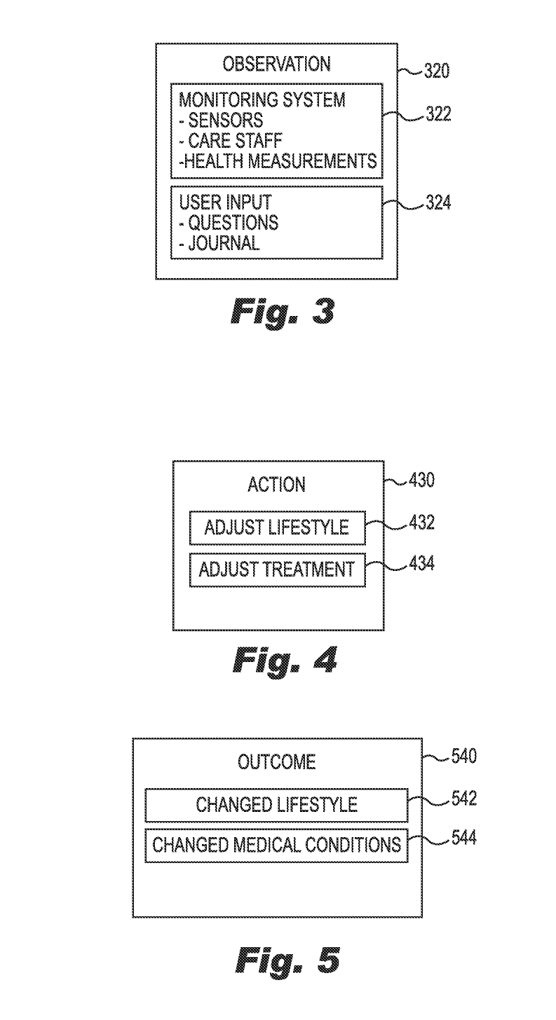

FIG. 3 illustrates observations 320 of an adaptive healthcare system in accordance with a number of embodiments of the present disclosure. The observations 320 in FIG. 3 can include observations by a monitoring system 322, user input 324, and health measurements 326, among other observations. The observations 320 can be stored in a healthcare file of a person. The care cycle of observation, action, and outcome stored in the healthcare file of a person can be used by an adaptive healthcare system to adapt healthcare for the person and/or to determine best healthcare protocols for a number of persons.

The monitoring system 322 can include a sensor system and/or observations made by healthcare staff. The observations by a sensor system can be related to the person's lifestyle, medical conditions, and/or medical history. Also, the observations by sensor system can be used to determined outcomes based on actions taken by the person. For example, the monitoring system 322 can include a sensor system that includes a number of sensors that can communicate to each other and/or a computing device. The sensing systems can communicate with other sensors and/or computing devices by transmitting signals wirelessly. The signals communicated between the number of sensors and/or computing devices can be analyzed and used to monitor and make observations 320 regarding the activities of a user in a dwelling. In various embodiments, a sensor system can include a number wireless access points that can provide wireless access to a wireless network, such as a Wireless Local Area Network (WLAN), by transferring signals on one or more channels between various components of the wireless network, such as sensors, base stations, and/or computing devices, among other components.

In a number of embodiments, the monitoring system 322 can include observations by healthcare staff. The observations by healthcare staff can include observations during medical appointments, observations during visits from healthcare staff to administer treatments, and/or observations during an evaluation of a person in a dwelling by the healthcare staff. The observations by healthcare staff can be related to the person's lifestyle, medical conditions, and/or medical history. Also, the observations by healthcare staff can be used to determine outcomes based on actions taken by the person.

Observations 320 can include user input 324 from a person based on responses to questions presented to the person. The questions can be presented to the person periodically, such as daily, for example. The questions can be used to make observations regarding the lifestyle and/or medical conditions of the person. In a number of embodiments, the questions can based upon feedback a healthcare professional would want due to changes in the person's lifestyle and/or treatment plan. In a number of embodiments, the number of questions can be presented to the person and answered by the person via a computing device. Also, the user input 324 based on responses to questions can be used to determine outcomes based on actions taken by the person.

Observations 320 can include user input 324 from a person based on a journal written by the person. In a number of embodiments, the journal can be an electronic journal that is input to the adaptive healthcare system via a computing device. The journal can be a personal medical journal that can include information regarding the lifestyle and/or medical conditions of the person. In a number of embodiments, the information in the journal can be related to the person's lifestyle and/or treatment plan and/or changes in the person's lifestyle and/or treatment plan. Also, the user input 324 based on the journal can be used to predict outcomes based on actions taken by the person.

Observations 320 can include healthcare measurements 326 of a person. The healthcare measurements 326 can be made at a kiosk. The kiosk can be a self-service kiosk that provides healthcare measurement equipment for the person to operate. For example, the kiosk can be provided in the person's dwelling and can be used by the person to report healthcare measurements. The kiosk can include a scale, a blood pressure monitor, and/or a blood sugar monitor, among other healthcare measurement equipment. The healthcare measurements 326 can be made by a healthcare professional. The healthcare measurements 326 can be made by healthcare professionals during medical appointments, during visits from healthcare staff to administer treatments, and/or during an evaluation of a person in a dwelling by the healthcare staff. The healthcare measurements 326 can be made periodically, such as daily, for example. The healthcare measurements can be used to make observations regarding the lifestyle and/or medical conditions of the person. The healthcare measurements 326 can be used to determine outcomes based on actions taken by the person.

FIG. 4 illustrates actions 430 of an adaptive healthcare system in accordance with a number of embodiments of the present disclosure. In FIG. 4, actions 430 include adjusting the lifestyle 432 of a person and adjusting treatment 434 of a person. The action 430 that adjust the lifestyle 432 and/or treatment 434 of a person can be stored in a healthcare file of the person. The actions 430 to adjust the lifestyle 432 and/or treatment 434 of a person can include instructions that are communicated to the person for implementation of the adjustments by the person. The actions 430 stored in the healthcare file of the person can be used by an adaptive healthcare system to adapt healthcare for the person and/or to determine best healthcare protocols for a number of persons.

Actions 430 that adjust the lifestyle 432 of a person can affect the person's eating, sleeping, and/or exercise routines, among other aspect of the person's lifestyle. Actions 430 that adjust the treatment 434 of a person can affect the healthcare provided to the person to treat a medical condition of the person and can include interventions to correct medical conditions of the person. The adjustments to the lifestyle 432 and treatment 434 of the person can be made as part of providing healthcare to the person. The adjustments to the lifestyle 432 and treatment 434 of the person can be based on observations of the person made by an adaptive healthcare system.

For example, if an adaptive healthcare system has observed that the person has high blood pressure, the adaptive healthcare system can provide an action that adjusts the lifestyle 432 of the person by reducing the amount of sodium consumed by the person in their diet. The person can implement the adjustment to their lifestyle by eating less sodium and can report observations to the adaptive healthcare system by providing responses to questions about what the person ate, providing blood pressure healthcare measurements, and/or providing a journal that details the food consumed by the person.

In another example, if an adaptive healthcare system has observed that the person has high blood pressure, the adaptive healthcare system can provide an action that adjusts the treatment 432 of the person by prescribing high blood pressure medicine for the person. The person can implement the adjustment to their treatment by taking the high blood pressure medicine and can report observations to the adaptive healthcare system by providing responses to questions whether the person took their high blood pressure medicine and/or providing blood pressure healthcare measurements.

In a number of embodiments, the observations of actions 430 that adjust the lifestyle 432 and/or treatment 434 can be analyzed and compared by an adaptive healthcare system to adapt healthcare for the person and/or to determine best healthcare protocols for a number of persons.

FIG. 5 illustrates outcomes of an adaptive healthcare system in accordance with a number of embodiments of the present disclosure. In FIG. 5, outcomes 540 include determining changes in lifestyle of a person and determining changes in the medical condition of a person. The outcomes 540 that include a changed lifestyle 542 and/or medical condition 544 of a person can be stored in a healthcare file of the person. The outcomes 540 stored in the healthcare file of the person can be used by an adaptive healthcare system to adapt healthcare for the person and/or to determine best healthcare protocols for a number of persons.

Outcomes 540 that include a changed lifestyle 442 of a person can include changes to the person's eating, sleeping, and/or exercise routines, among other aspect of the person's lifestyle. Outcomes 540 that include changed medical conditions 544 of a person can include changes to in the severity of a medical condition, such as a disease, afflicting a person. The changed lifestyle 542 and medical condition 544 of the person can be a result of actions that include adjustments to the lifestyle and treatment of the person, such as actions 330 discussed in association with FIG. 3, made by an adaptive healthcare system. The changed lifestyle 542 and medical condition 544 of the person can be determined by observations, such as observations 220 discussed in association with FIG. 2.

Outcomes 540 can include the cost involved in the treatment of a person, the relationship of costs involved in the treatment of a person to the success of the treatment of the person, the satisfaction of a person with the treatment of a person, and/or the maintenance of the health and safety of the person during treatment. The satisfaction with the treatment of the person can includes the satisfaction of the person being treated, the family and friends of the person being treated, and/or the medical staff providing the treatment to the person.

For example, if an adaptive healthcare system has observed that the person has high blood pressure, the adaptive healthcare system can determine an outcome based on observations of an action that adjusts the lifestyle of the person, such as reducing the amount of sodium consumed by the person in their diet and/or taking a high blood pressure medicine. The outcome can be determined by using information provided in observations that include responses to questions about what the personate, blood pressure healthcare measurements, and/or a journal that details the food consumed by the person.

In another example, if an adaptive healthcare system has observed that the person has high blood pressure, the adaptive healthcare system can provide an action that adjusts the treatment 432 of the person by prescribing high blood pressure medicine for the person. The person can implement the adjustment to their treatment by taking the high blood pressure medicine and can report observations to the adaptive healthcare system by providing responses to questions whether the person took their high blood pressure medicine and/or providing blood pressure healthcare measurements.

In a number of embodiments, the observations of a person in an environment can be linked to actions that can adjust a person's lifestyle and/or a person's treatment plan and the outcomes that change a person's lifestyle and/or a person's medical condition as a result of the actions that adjust a person's lifestyle and/or a person's treatment plan. The information associated with these observations, actions, and outcomes can be stored in a healthcare file to adjust the healthcare of the person and/or used to determine a best care protocol for people with similar lifestyles and/or medical conditions.

In a number of embodiments, the observations, actions, and outcomes of an adaptive healthcare system can be implemented using a social network. The social network can include the person receiving healthcare, the family of the person receiving healthcare, and/or the healthcare professionals proving healthcare to the person. The observations of the person can be communicated to the person receiving healthcare, the family of the person receiving healthcare, and/or the healthcare professionals proving healthcare to the person via a social network. The actions that adjust the lifestyle and/or treatment plan of the person can be communicated to the person receiving healthcare, the family of the person receiving healthcare, and/or the healthcare professionals proving healthcare to the person via a social network. The outcomes that include a changed lifestyle and/or medical condition can be communicated to the person receiving healthcare, the family of the person receiving healthcare, and/or the healthcare professionals proving healthcare to the person via the social network.

Although specific embodiments have been illustrated and described herein, those of ordinary skill in the art will appreciate that an arrangement calculated to achieve the same techniques can be substituted for the specific embodiments shown. As one of ordinary skill in the art will appreciate upon reading this disclosure, various embodiments of the invention can be performed in one or more devices, device types, and system environments including networked environments.

Combination of the above embodiments, and other embodiments not specifically described herein will be apparent to those of skill in the art upon reviewing the above description. The scope of the various embodiments of the disclosure includes other applications in which the above structures and methods can be used. Therefore, the scope of various embodiments of the disclosure should be determined with reference to the appended claims, along with the full range of equivalents to which such claims are entitled.

In the foregoing Detailed Description, various features may have been grouped together in a single embodiment for the purpose of streamlining the disclosure. This method of disclosure is not to be interpreted as reflecting an intention that the embodiments of the invention require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for adapting healthcare, comprising:
creating a healthcare file for each of a number of persons, wherein each of the healthcare files includes outcomes associated with changes in a lifestyle and/or medical condition of the number of persons, adjustments to the lifestyle and/or treatment of the number persons, and observations of the number of persons in an environment; and
adapting healthcare of the number of persons using decision support based on the healthcare files.

2. The method of claim 1, wherein observation of the number of person in an environment include observations from a sensor system.

3. The method of claim 1, wherein observation of the number of person in an environment include observations from a healthcare professional.

4. The method of claim 1, wherein creating the healthcare file includes providing lifestyle information, medical history information, and medical condition information for the number of persons.

5. The method of claim 4, wherein adjustments to the lifestyle of the number of persons include adjustments to the number of person's diet.

6. The method of claim 1, wherein adjustments to the lifestyle of the number of persons include adjustments to the number of person's exercise routine.

7. The method of claim 1, wherein the method includes providing the number of persons with instruction for implementing the adjustments to the lifestyle and/or treatment of the number persons.

8. The method of claim 1, wherein the method includes determining an outcome including a changed lifestyle based on observations of the number person in the environment.

9. The method of claim 1, wherein the method includes determining an outcome including a changed medical condition based on observations of the number person in the environment.

10. A method for adapting healthcare, comprising:
implementing an action predicted to correct a medical condition based observations, actions, and outcomes of a number of persons in an environment;
determining a best practice protocol for the number of persons, wherein the best practice protocol is based on changes in lifestyle and/or medical conditions of the number of persons that resulted from adjustments to the lifestyles and/or treatments of the number persons through implementation of the action; and
adapting care of the number of persons to include the best practice protocol.

11. The method of claim 10, wherein the method includes recording observations of the number of person in a number of healthcare files.

12. The method of claim 10, wherein determining the best practice protocol for the number of persons based on the number of person having a common medical condition.

13. The method of claim 12, wherein determining the best practice protocol for the number of persons includes developing a treatment plan for the common medical condition.

14. The method of claim 10, wherein changes in the lifestyle and/or medical condition of the number of persons are determined based on observations made by a sensor system and/or medical professionals.

15. The method of claim 14, wherein changes in the lifestyle and/or medical condition of the number of persons are determined based on observations made through health measurements at a self-serve kiosk.

16. A system for adaptive healthcare, comprising:
an environment that includes a person in a dwelling; and
a computing device in communication with the environment, the computing device including a memory having instructions storable thereon and executable by a processor to:
record observations of the person through monitoring systems, input of the person, and a health measurement input;
provide actions for the person to perform to adjust their lifestyle and treatment plan based on the observations of the person; and
determine changes in the lifestyle and/or medical conditions of the person based on the observations of the person and the actions for the person to perform to adjust their lifestyle and treatment plan.

17. The system of claim 16, wherein the recorded observations are communicated to healthcare professionals via a social network.

18. The system of claim 17, wherein the actions for the person to perform to adjust their lifestyle and treatment plan are determine by healthcare professionals based on the recorded observations communicated via the social network.

19. The system of claim 16, wherein observations of the person are recorded through input of the person that includes responses to a series of questions about the adjustments to their lifestyle and treatment plan.

20. The system of claim 16, wherein the number of questions about the adjustments to the person lifestyle and treatment plan are provided by a healthcare professional.

21. The system of claim 16, wherein the actions for the person to perform to adjust their lifestyle and treatment plan are determine by an assessment training through analysis of observations of the person.
